(19) United States
(12) Patent Application Publication
(10) Pub. No.: US 2016/0135533 A1
(43) Pub. Date: May 19, 2016

(54) CONVENIENT-TO-CARRY HELMET STAND

(71) Applicant: David Turner, Asheville, NC (US)

(72) Inventor: David Turner, Asheville, NC (US)

(21) Appl. No.: 15/003,470

(22) Filed: Jan. 21, 2016

Related U.S. Application Data
(63) Continuation-in-part of application No. 14/168,739, filed on Jan. 30, 2014.

(51) Int. Cl. A42B 3/00; F16M 11/22; F16M 11/04

(52) U.S. Cl. CPC A42B 3/006; F16M 11/04; F16M 11/22

(57) ABSTRACT

There is provided a convenient-to-carry helmet stand. The portable helmet stand includes a first body portion, a second body portion, and a receipt surface on which a crown portion of a helmet can be placed in an operating mode of the portable helmet stand. The first body portion and the second body portion are operationally connected to one another such that the first body portion and the second body portion can be disposed, in an operating mode of the portable helmet stand, to delimit an operating mode width between themselves.

### CROSS-REFERENCE TO RELATED APPLICATIONS

This application claims the benefit of U.S. patent application Ser. No. 14/168,739, filed Jan. 30, 2014.

### FIELD OF THE INVENTION

The field of the invention is portable helmet stands.

### BACKGROUND

The wearing of a motorcycle helmet when operating or riding on a motorcycle is often required by virtue of traffic safety laws and regulations and the wearing of a motorcycle helmet remains in areas not having such traffic safety laws. Whether the wearing of a motorcycle helmet is legally mandated or not, a good number of motorcycle operators and passengers choose to wear such helmets when riding on a motorcycle. When such individuals dismount from the motorcycle, they will often take off the helmet, particularly if they do not plan to ride again soon.

Motorcycles typically have limited or no interior storage space for storing a motorcycle helmet. Riders of powered two-wheel vehicles other than motorcycles, such as riders of scooters or the like, also often choose to wear a safety helmet when operating their vehicle. These safety helmets, like motorcycle helmets, are often formed of relatively hard material which covers a substantial portion of a user's head and may include a guard over the face area. By virtue of their safety oriented configuration, motor vehicle safety helmets can often be cumbersome and have substantial weight, with the result that the helmet wearing operator or passenger desires to shed the helmet when the motorcycle or scooter is not being operated. However, because of the typical rigid bulky configuration of a safety helmet, it can be inconvenient to carry or hold the helmet.

U.S. Pat. No. 4,253,630 to Rigg discloses a solid ring support stand for a helmet. However, the solid ring support itself is not altogether convenient to carry along during a motorcycle ride. The need exists, therefore, for a convenient and stable structure for supporting a helmet when the helmet is in a standby mode in which it is not being worn by a user. A further object is to provide a helmet support that permits a helmet to be stably oriented in a standby mode so that other driving accessories can be stored inside the helmet. Another object is to provide a helmet support that may be compactly stored.

### BRIEF SUMMARY OF THE INVENTION

The present invention solves the above-mentioned problems by providing a portable helmet stand operable to support a helmet on a reference surface. The portable helmet stand includes:

a first body portion, a second body portion, and a receipt surface on which a crown portion of a helmet can be placed in an operating mode of the portable helmet stand. According to particular features of one embodiment of the portable helmet stand, the first body portion and the second body portion are operationally connected to one another such that the first body portion and the second body portion can be disposed, in an operating mode of the portable helmet stand, to delimit an operating mode width between themselves. Furthermore, the first body portion and the second body portion can be disposed, in a standby mode of the portable helmet stand, to delimit a standby mode width between themselves that is less than the operating mode width. The receipt surface is maintained by the portable helmet stand in its operating mode at a spacing above the reference surface.

It is one object of the present invention to provide a new and improved helmet stand which may be easily and efficiently manufactured.

It is a further object of the present invention to provide a new and improved helmet stand that is convenient to deploy and to carry in a collapsed position. The helmet stand may be twisted and folded to form a plurality of concentric loop rings for compact storage.

The present invention is generally directed towards a convenient-to-carry helmet stand. The principles of the present invention however, are not limited to the particular configurations of helmet stands described herein. It will be understood that, in light of the present disclosure, the helmet stand of the present invention, and its associated components and features, can be successfully used in connection with a variety of helmets and headgear. Additionally, to assist in the description of the helmet stand of the present invention, words such as top, bottom, front, rear, right and left may be used to describe the accompanying figures, which may be but are not necessarily drawn to scale. It will be appreciated that the helmet stand of the present invention can also be located in a variety of desired positions and/or orientations.

### BRIEF DESCRIPTION OF THE DRAWINGS

Other features and advantages of the invention will become apparent to those skilled in the art upon review of the following detailed description, claims, and drawings.

FIG. 1 is a side elevational view of one embodiment of the helmet stand of the present invention in its operating mode and deployed on a table;

FIG. 2 is a top perspective view of one embodiment of the helmet stand shown in FIG. 1 in its operating mode;

FIG. 3 is a top perspective view of one embodiment of the helmet stand shown in FIG. 1 in its standby mode;

FIG. 4 is a front plan view of a sports safety helmet having a hard case for retaining the helmet stand;

FIG. 5 is a front plan view of a powered water craft having a hard case for retaining the helmet stand;

FIG. 6 is a front plan view of a motorized scooter having a hard case for retaining the helmet stand;

FIG. 7 is a top perspective view of another embodiment of the helmet stand of the present invention in its operating mode;

FIG. 8 is a front plan view of the helmet stand shown in FIG. 7 in its operating mode;

FIG. 9 is a top perspective view in partial section of a further embodiment of the helmet stand of the present invention in its operating mode;

FIG. 10 is a top perspective view of the helmet stand shown in FIG. 9 in its standby mode;

FIG. 11 is a top perspective view of an additional embodiment of the helmet stand of the present invention in its operating mode;

FIG. 12 is a top perspective view of yet another embodiment of the helmet stand of the present invention in its operating mode;

FIG. 13 is a top perspective view of an embodiment of the helmet stand of the present invention being placed in a standby mode;

FIG. 14 is a side perspective view of an embodiment of the helmet stand of the present invention being placed in a standby mode; and

FIG. 15 is a top perspective view of an embodiment of the helmet stand of the present invention in a standby mode.

### DETAILED DESCRIPTION OF THE DRAWINGS

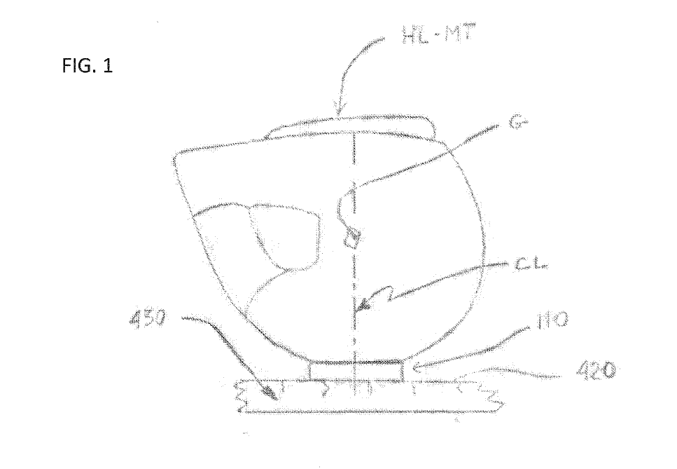

As seen in FIG. 1, which is a side elevational view of one embodiment of the helmet stand of the present invention in its operating mode in which it is deployed to support a helmet on a table, a helmet stand 110 is configured as an easily carried continuous loop band that folds or collapses for convenient carrying such as, for example, for carrying in a pocket. When the helmet stand 110 is deployed in a operating mode, as will be described in more detail herein, the helmet stand 110 is configured to assume a circular shape that permits the helmet stand 110 to be placed on a surface in a manner in which the helmet stand 110 generally maintains its circular shape and can receive the curved crown of the top of a helmet placed on the top edge of the loop band. The deployment of the helmet stand 110 in its operating mode can be seen in FIG. 1, which shows the helmet stand located on a horizontal table surface and supporting a helmet thereon. As shown in FIG. 1, the helmet stand 110 is configured to maintain the curved crown of the top of a helmet HL-MT at a spacing above a surface and the surface can be any one of a variety of surfaces, including slippery or non-slippery surfaces, horizontal or non-horizontal surfaces, and smooth or non-smooth surfaces. Solely for the sake of illustration of a representative surface, the helmet stand 110 is shown in FIG. 1 as being disposed such that it is at least partially in connection with a table surface 420 of an outdoor table 430, whereupon the helmet HL-MT will not detrimentally roll around the table surface or fall from the table and undesirably come into contact with dirt or debris or sustain structural damage. Thus, the helmet stand not only performs an organizing an aesthetic function, it also performs a preservation function in that it helps the helmet owner to maintain the structural integrity of the helmet. A stable position of the helmet HL-MT on the helmet stand 110 can be achieved, for example, by orienting the helmet so that its center of gravity G is on, or substantially proximate to, a center line CL of the helmet stand 110.

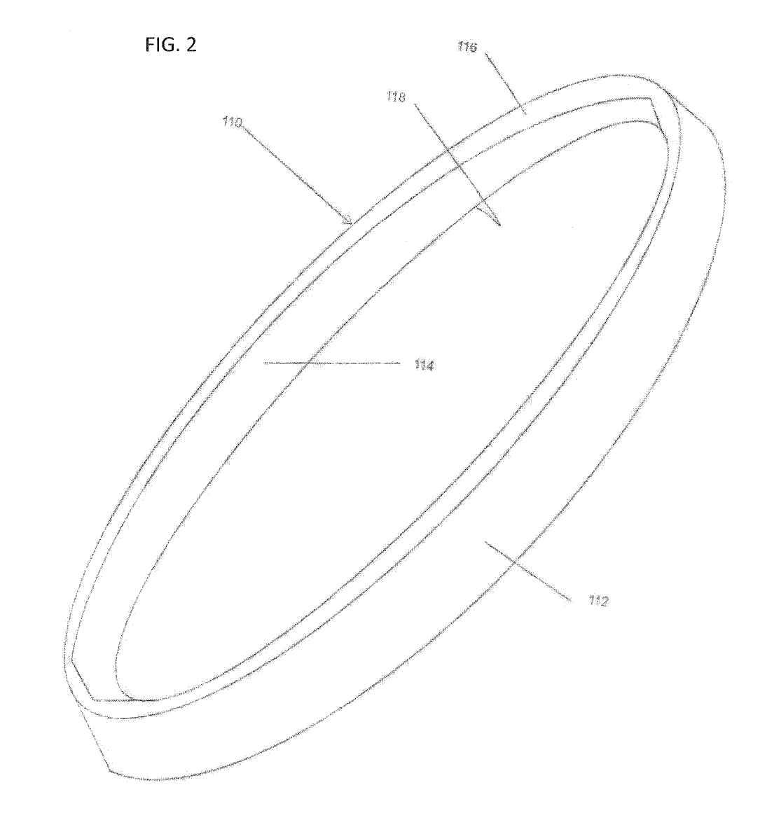

With further reference to FIG. 1, and with reference also to FIG. 2, which is a top perspective view of one embodiment of the helmet stand shown in FIG. 1 in its operating mode, and FIG. 3, which is a top perspective view of one embodiment of the helmet stand shown in FIG. 1 in its standby mode, the helmet stand 110 is formed as a continuous loop and has an outer periphery 112, an inner periphery 114, a top surface 116, and a lower surface 118. The helmet stand 110 can be formed of a single extent of a flexible material such as leather or natural or synthetic fabric that is a woven or a non-woven material. Additionally, the helmet stand 110 can be formed via an assembly process in which a single extent of flexible material has its opposite ends joined to one another to form a closed or continuous loop.

Having now disclosed the advantageous deployment of the helmet stand 110 in its operating mode, the convenience and portability of the helmet stand 110 in its standby mode will now become apparent with reference to FIG. 3. The helmet stand 110 is deployable from its operating mode into its standby mode via a deflection of the helmet stand 110 in a manner that reduces a with dimension of the helmet stand 110 from an operating width OP-W that the helmet stand 110 is expanded to in its operating mode to a standby mode width ST-W that is less than its operating width OP-W. As can be understood, this deflection of the helmet stand 110 re-configures the helmet stand 110 such that the helmet stand 110 no longer presents a circular footprint as it does in its operating mode but, instead, presents a footprint that may be elliptical or oblong in shape. The helmet stand 110 can be deflected from its operating mode into its standby mode via, for example, grasping the helmet stand 110 in one hand and squeezing the helmet stand 110 such that opposing portions of the inner periphery 114 are moved into contact with one another. Depending upon the material properties of the helmet stand 110, the helmet stand 110 may be resiliently biased to automatically assume the circular footprint (i.e., its footprint in its operating mode) when any deflection force being applied to the helmet stand 110 is ceased.

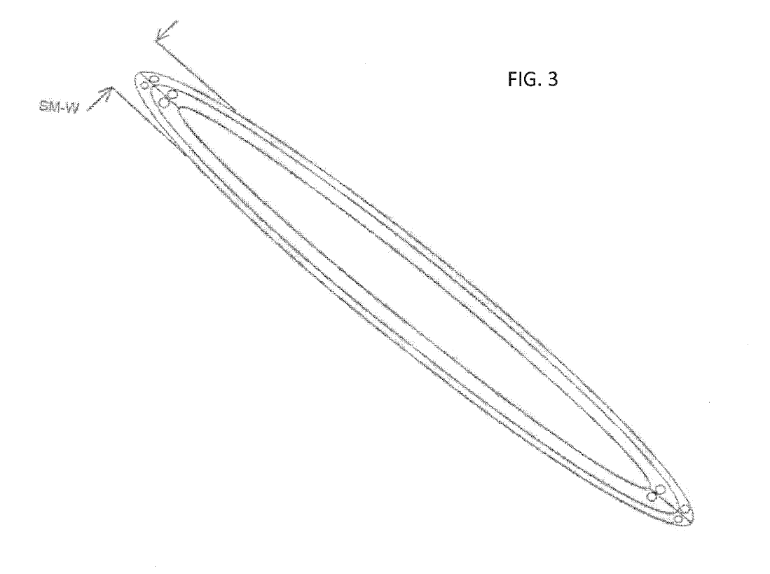

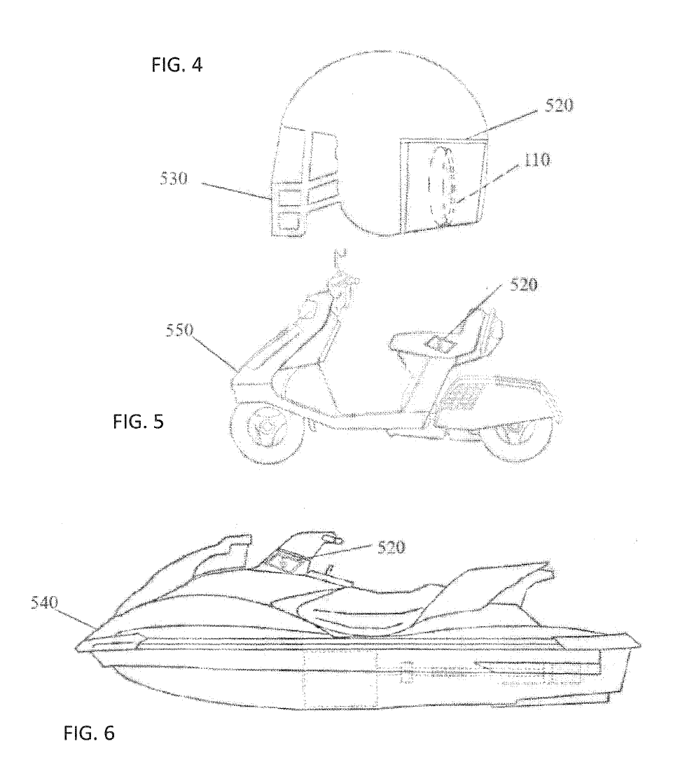

With the helmet stand 110 having an elliptical or oblong footprint in its standby mode, the helmet stand 110 can be easily placed into a container or into a pocket in a piece of clothing. Moreover, the helmet stand 110 can be stowed in a purpose-built container such as, for example, a hard case formed of a durable material such as leather or a polymer. As seen in FIG. 4, which is a front plan view of a sports safety helmet having a hard case for retaining the helmet stand 110, a hard case 520 in the form of a molded polyurethane or polymeric material is fixedly secured to an outer surface of a sports safety helmet 530. The hard case 520 has an interior sized in correspondence with the helmet stand 110 such that the helmet stand 110 can be fully inserted into the hard case. As seen in FIG. 5, which is a front plan view of a powered water craft having a hard case for retaining the helmet stand 110, the hard case 520 is fixedly secured to an outer surface of a powered water craft 540. As seen in FIG. 6, which is a front plan view of a motorized scooter having a hard case for retaining the helmet stand 110, the hard case 520 is fixedly secured to an outer surface of a scooter 550.

In lieu of, or in addition to, the hard case 520, a hook and loop fastener component attached to the helmet stand can be provided for releasable securement with a corresponding hook and loop fastener component secured to, for example, a helmet or the exterior of a saddlebag of a motor vehicle, such as the motorcycle MT-C.

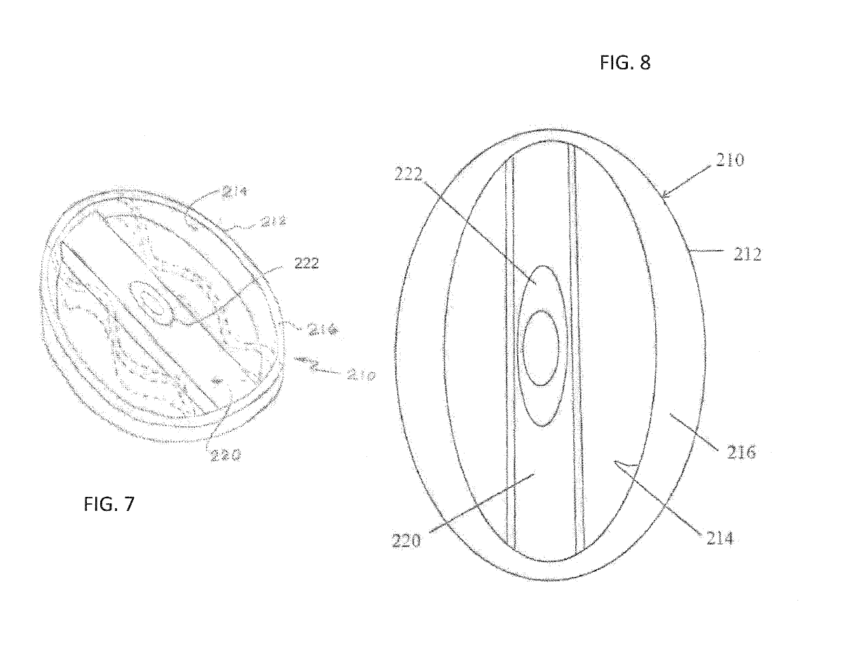

Reference is now had to FIG. 7 which is a top perspective view of another embodiment of the helmet stand of the present invention in its operating mode, and FIG. 8, which is a front plan view of the helmet stand shown in FIG. 7 in its operating mode. A helmet stand 210 is formed as a continuous loop and has an outer periphery 212, an inner periphery 214, a top edge 216, and a lower edge 218. Additionally, the helmet stand 210 includes a cross bar 220 having a recess 222 located at a mid-length location on the cross bar. The cross bar 220 has one end fixedly secured to the inner periphery 214 and an opposite end fixedly secured to the inner periphery 214 diametrically opposite to the location at which the one end of the cross bar is fixedly secured to the inner periphery 214. The helmet stand 210 can be formed of a single extent of a flexible material such as leather or natural or synthetic fabric that is a woven or a non-woven material. The helmet stand 210 is deployable from its operating mode into its standby mode via a deflection of the helmet stand 210 in a manner that reduces a width dimension of the helmet stand 210 from an operating width OP-W that the helmet stand 210 is expanded to in its operating mode to a standby mode width ST-W that is less than its operating width OP-W. FIG. 7 shows a broken line profile of one possible configuration of the outer periphery 212, the inner periphery 214, the top edge 216, and the lower edge 218 that can be achieved by compressing these components of the helmet stand 210 toward the cross bar 220 to reduce the helmet stand from its operating width OP-W to its standby mode width ST-W. As seen in FIG. 7, deploying the helmet stand 210 from its operating mode into its standby mode does not result in a deflection or reduction in length of the cross bar 220. Nonetheless, the helmet stand 210 in its standby mode is still easily disposed into a pocket of an article of clothing or a container.

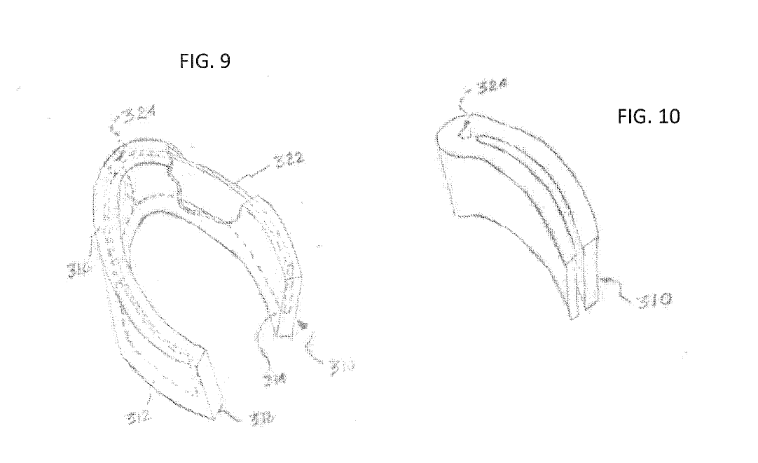

Reference is now had to FIG. 9, which is a top perspective view in partial section of a further embodiment of the helmet stand of the present invention in its operating mode, and FIG. 10, which is a top perspective view of the helmet stand shown in FIG. 9 in its standby mode. A helmet stand 310 is formed as an extent having a pair of opposite ends that are not secured to one another—i.e., the helmet stand 310 is not formed as a continuous loop. The helmet stand 310 has an outer periphery 312, an inner periphery 314, a top edge 316, and a tower edge 318. As seen in FIG. 9, the helmet stand 310 includes a pair of interior legs 322 each formed of a shape memory material such as, for example, a thin gauge spring steel and the interior legs 322 are handedly connected to one another at a hinge 324. The interior legs 322 and the hinge 324 are enclosed in an outer sheath material that may be a fabric material.

The helmet stand 310 is deployable from its operating mode into its standby mode via a deflection of the helmet stand 310 in a manner that causes one of the interior legs 322 be pivoted about the hinge 324 toward the other interior leg 322 while at the same time, the pivoting interior leg flexes so that its curvature assumes a new profile that generally corresponds to the curvature of the other interior leg (which has not flexed during the pivoting of the one respective interior leg). The flexing of the one respective interior leg permits the pair of interior legs 322 to nest with one another, as seen in FIG. 10, and thereby reduce the overall width of the helmet stand 310, thereby providing a convenient overall reduced shape for storage in, for example, a pocket of a jacket or a pocket of a pair of pants.

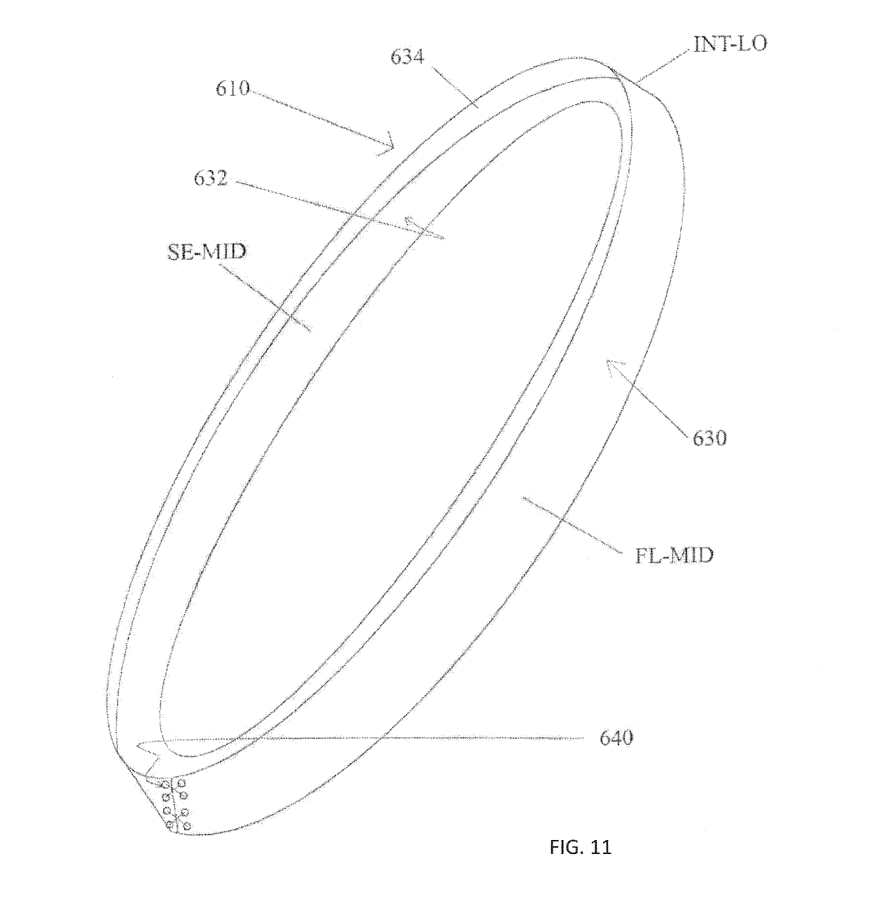

Reference is now had to FIG. 11, which is a top perspective view of an additional embodiment of the helmet stand of the present invention in its operating mode. A portable helmet stand 610 is operable to support a helmet on a reference surface i.e., the surface of a table such as a picnic table or a kitchen table. The portable helmet stand is formed of a single extent of a leather material whose ends are connected to one another in a manner described in more detail herein. The portable helmet stand 610 includes a first body portion 630 that includes one end of the leather extent and a second body portion 632 that includes the other end of the leather extent.

The first body portion 630 and the second body portion 632 are operationally connected to one another such that the first body portion and the second body portion can be disposed, in an operating mode of the portable helmet stand 610, to delimit an operating mode width between themselves and such that the first body portion 630 and the second body portion 632 can be disposed, in a standby mode of the portable helmet stand 610, to delimit a standby mode width between themselves that is less than the operating mode width. The portable helmet stand 610 includes a receipt surface 634 on which a crown portion of a helmet can be placed in an operating mode of the portable helmet stand 610, the receipt surface being maintained by the portable helmet stand 610 in its operating mode at a spacing above the reference surface.

The first body portion 630 and the second body portion 632 form a continuous loop and the first body portion 630 and the second body portion 632 each have an outer periphery and an inner periphery and circumferentially non-contiguous portions of the inner peripheries of the first body portion 630 and the second body portion 632 are in contact with one another in the standby mode of the portable helmet stand. The first body portion 630 and the second body portion 632 are contiguous to one another at an interface location INT-LO and, in the standby mode of the portable helmet stand, a mid location FI-MID of the first body portion 630 and a mid location SE-MID of the second body portion 632, which are circumferentially non-contiguous with one another, are in contact with one another.

The receipt surface on which a crown portion of a helmet can be placed is a continuous loop surface delimiting an upper surface of the first body portion 630 and the second body portion 632 laterally intermediate the outer and the inner peripheries of the first body portion and the second body portion. The upper surface of the first body portion and the second body portion has a descending profile as viewed laterally in the direction from the outer inner peripheries of the first body portion 630 and the second body portion 632 toward the inner peripheries of the first body portion and the second body portion. In particular, the upper surface of the first body portion and the second body portion has a curved profile. The ends of the leather extent are interconnected to one another via stitching 640 that extends to and between the first body portion 630 and the second body portion 632. In lieu of the stitching 640, the ends of the leather extent can be interconnected to one another via any suitable connecting technique including, for example, via grommets, clasps, welding of the leather to itself, a wrap around securing loop, notching, interleaving, and so forth.

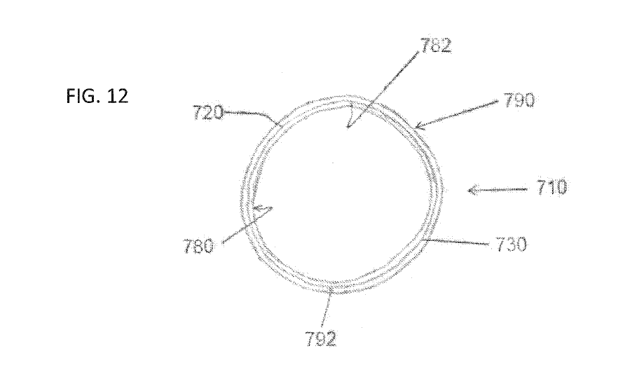

Reference is now had to FIG. 12, which is a top perspective view of yet another embodiment of the helmet stand of the present invention in its operating mode. A portable helmet stand 710 is operable to support a helmet on a reference surface—i.e., the surface of a table such as a picnic table or a kitchen table. The portable helmet stand is formed of two plies of a leather material. The portable helmet stand 710 includes a first body portion 730 and a second body portion 732. The portable helmet stand 710 is formed of an inner closed loop of leather 780 that has its two axial ends connected to one another at a butt seam 782 and an outer closed loop of leather 790 that has its two axial ends connected to one another at a butt seam 792. The outer closed loop of leather 790 has an inner periphery that is compatibly configured with the outer periphery of the inner closed loop of leather 780 such that the inner closed loop of leather 780 and the outer dosed loop of leather 790 are in abutting engagement with one another of sufficient tenacity to maintain the two closed loops of leather 780, 790 in abutting engagement with one another.

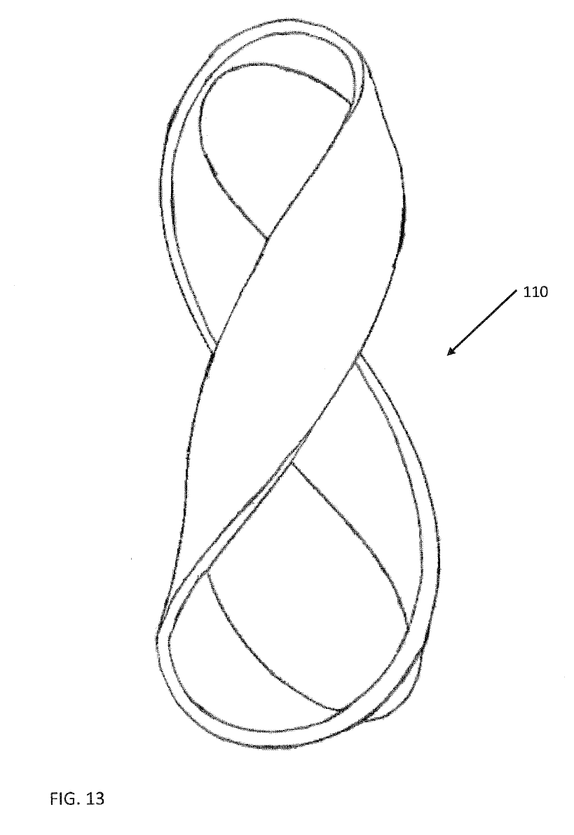

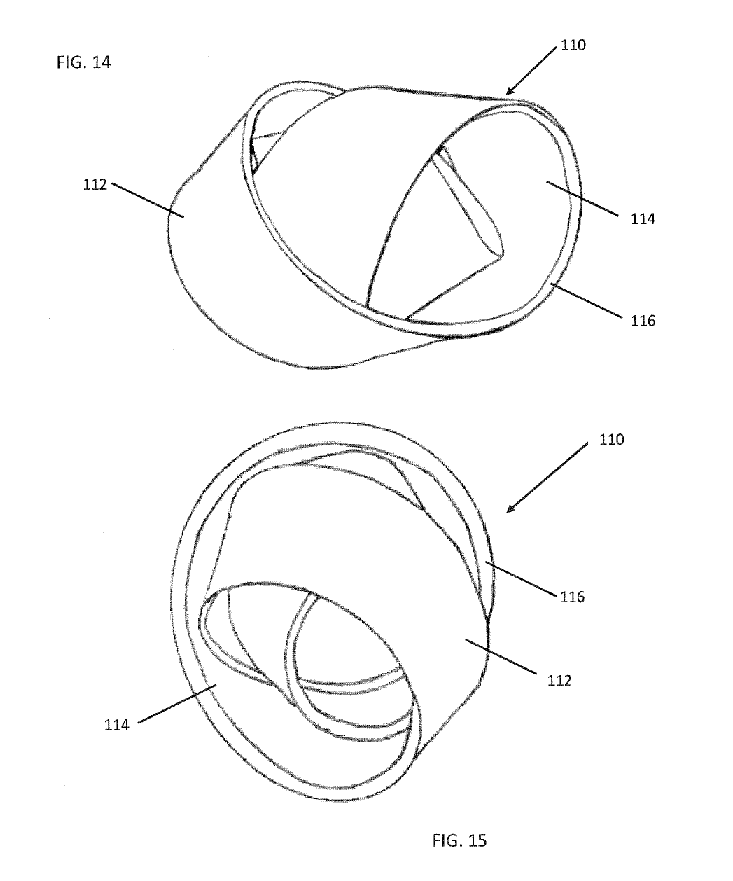

FIG. 13 shows a top perspective view of an embodiment of the helmet stand of the present invention being placed in a standby mode. A helmet stand 110 is made of a flexible polymeric material such as rubber, silicone, neoprene, polyethylene, polyvinyl chloride, or nylon. The material must be of sufficient flexibility so that a user may grasp the helmet stand 110 and twist it so that it forms a figure eight shape. As a user continues to twist the helmet stand 110, as shown in FIGS. 14-15, the helmet stand 110 is deformed until at least a portion of the outer periphery 112 is within at least a portion of the inner periphery 114 of the helmet stand 110. In this configuration, the helmet stand 110 is compactly positioned into a plurality of concentric loop rings for easier storage. With the helmet stand 110 in this collapsed configuration, the helmet stand 110 can be easily placed into a container or into a pocket in a piece of clothing.

Although this invention has been disclosed and described in its preferred forms with a certain degree of particularity, it is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the invention as hereinafter claimed.

What is claimed is:

1. A portable helmet stand for supporting a helmet on a reference surface and capable of being positioned in both a deployed and collapsed configuration, the portable helmet stand comprising:
a. a continuous loop of flexible polymeric material having
i. a first body portion comprising the outer periphery of the continuous loop,
ii. a second body portion comprising the inner periphery of the continuous loop,
iii. a receipt surface comprising the top edge of the continuous loop, and
iv. a support surface comprising the bottom edge of the continuous loop;
b. wherein the continuous loop is capable of being sufficiently rigid in a deployed configuration such that, while the support surface is at least partially in connection with the reference surface, a crown portion of a helmet may be placed upon the receipt surface without the crown portion touching the reference surface; and
c. wherein the continuous loop is capable of being sufficiently flexible in a collapsed configuration such that the continuous loop is capable of being twisted into at least one additional loop wherein at least a portion of the first body portion is within a portion of the second body portion.

2. The portable helmet stand of claim 1, wherein the continuous loop is capable of being twisted into at least two additional loops wherein at least a portion of the first body portion is within a portion of the second body portion.

3. The portable helmet stand of claim 1, wherein the flexible polymeric material is selected from the group consisting of rubber, silicone, neoprene, polyethylene, polyvinyl chloride, or nylon.
